(19) United States
(12) Patent Application Publication
(10) Pub. No.: US 2026/0138447 A1
(43) Pub. Date: May 21, 2026

(54) VEHICLE AUDIBLE SUPPORT SYSTEM

(71) Applicant: Toyota Motor Engineering & Manufacturing North America, Inc., Plano, TX (US)

(72) Inventors: Christopher M. Higgins, Ann Arbor, MI (US); Markiyan Andruchowycz, Ypsilanti, MI (US)

(73) Assignees: Toyota Motor Engineering & Manufacturing North America, Inc., Plano, TX (US); Toyota Jidosha Kabushiki Kaisha, Toyota-shi (JP)

(21) Appl. No.: 18/950,592

(22) Filed: Nov. 18, 2024

(51) Int. Cl. B60K 35/26; B60W 50/04; B60W 50/14; H04L 67/12

(52) U.S. Cl. CPC B60K 35/265; B60W 50/045; B60W 50/14; H04L 67/12

(57) ABSTRACT

Methods, systems, and apparatus for a vehicle audible support system include one or more vehicle sensors, a vehicle speaker, a data storage device, and one or more processors (e.g., one or more ECUs) in electronic communication with the vehicle sensor(s) and the data storage device. The processor(s) is/are configured to receive a vehicle sensor input via the one or more vehicle sensors and, in response to determining that the vehicle sensor input matches a preset input stored in the data storage device, output an audio signal to the vehicle speaker with a predetermined message to provide assistance to a driver of the vehicle.

### BACKGROUND

### Field

The present disclosure relates generally to an active or proactive vehicle support system, and more specifically to a vehicle audible support system for providing audible messages to a driver in language understandable by the driver.

### Description of the Related Art

Modern vehicles include a network of electronic systems and control modules, which may be associated with several different aspects of the vehicle, such as the powertrain, braking, steering, suspension, climate control, windows, lighting, entertainment, communications, and/or navigation. Operation of various aspects of the vehicle can be performed by a driver in a manner that is generally predetermined by the manufacturer of the vehicle. Moreover, the driver input required for operating various aspects of the vehicle can vary among different vehicles and different vehicle manufacturers. Owners of modern vehicles may have difficulty operating various aspects of the vehicle, particularly when operating a vehicle that the driver is not accustomed to or familiar with.

Accordingly, it is desirable to provide systems, methods, and techniques for automatically providing driver assistance in real-time.

### SUMMARY

One aspect of the subject matter described in this disclosure may be embodied in a vehicle audible support system. The vehicle audible support system can include a data storage device and one or more processors in electronic communication with the data storage device. The one or more processors can be configured to receive a vehicle sensor input via the one or more vehicle sensors. The one or more processors can be configured to, in response to determining that the vehicle sensor input matches a preset input stored in the data storage device, output an audio signal to the vehicle speaker with a predetermined message based upon the vehicle sensor input to provide assistance to a driver of a vehicle.

In another aspect, the subject matter may be embodied in a vehicle. The vehicle can include a vehicle speaker, one or more vehicle sensors, and a vehicle audible support system. The vehicle audible support system can include one or more processors in electronic communication with the one or more vehicles sensors and a data storage device. The one or more processors are configured to receive a vehicle sensor input via the one or more vehicle sensors. The one or more processors are configured to, in response to determining that the vehicle sensor input matches a preset input stored in the data storage device, output an audio signal to the vehicle speaker with a predetermined message based upon the vehicle sensor input to provide assistance to a driver of the vehicle.

These and other embodiments may optionally include one or more of the following features.

The one or more processors can be configured to monitor the one or more vehicle sensors for the vehicle sensor input.

The one or more vehicle sensors can include a start/stop button of the vehicle. The vehicle sensor input can include a depressing of the start/stop button.

The one or more vehicle sensors can include a wheel speed sensor, an accelerator pedal position sensor, a brake pedal position sensor, a gear selector position sensor, a push start switch input sensor, a steering wheel angle sensor, a stalk control setting sensor, a light sensor, a fuel door position sensor, a battery sensor, a fuel sensor, a park brake position sensor, and/or a hood latch position sensor.

The preset input can correspond to one or more of the following scenarios:
the driver presses a start/stop button while a vehicle speed is greater than zero;
an accelerator input is detected while a brake is depressed for greater than a first predetermined duration;
a battery or fuel is low detected by a battery charge or fuel sensor or a battery management system;
a brake input is detected while the vehicle speed is not decreasing for greater than a second predetermined duration;
the vehicle is detected in a Neutral gear position while the vehicle speed is greater than zero;
the accelerator input is detected while the vehicle is in the Neutral gear position;
the vehicle is out of a Park gear position while an ignition is off;
a turn signal remains on for greater than a predetermined duration while the vehicle continues moving straight;
the turn signal remains on for greater than a predetermined distance while the vehicle continues moving straight;
a fuel door and/or an electric charging door is open while the vehicle speed is greater than zero;
a parking brake is on while the vehicle is not in the Park gear position;
a headlamp is set to an off position while a sensed light intensity indicates it is dark outside and the vehicle speed is greater than zero;
a hood or a tailgate is not fully latched while the vehicle speed is greater than zero; and/or
a hood or a tailgate is not fully latched while the vehicle is not in the Park gear position.

The predetermined message can include an audible message to the driver that at least one or more of:
provides instructions to the driver on how to stop a vehicle engine;
a brake input is detected;
the vehicle is in Neutral or in Park;
the vehicle is out of Park;
a turn signal is on;
a fuel or electric charging door is open;
a parking brake is on;
a headlamp is switched off; and/or
a vehicle fuel door or gas cap, electric charging port, tail gate, trunk, frunk or hood is open.

The one or more processors can include at least one or more of an electronic control unit (ECU), an electronic fuel injection (EFI) ECU, and/or a certification ECU configured to receive the vehicle sensor input via the one or more vehicle sensors. The one or more processors can include a multimedia ECU configured to wirelessly or wired send or transmit the audio signal to the vehicle speaker.

In another aspect, the subject matter may be embodied in a method for providing assistance to a driver of a vehicle. The method can include receiving a vehicle sensor input at one or more processors via one or more vehicle sensors, the one or more processors are in electronic communication with one or more vehicles sensors and a data storage device. The method can include, in response to determining that the vehicle sensor input matches a preset input stored in the data storage device, outputting an audio signal to a vehicle speaker with a predetermined message based upon the vehicle sensor input to provide the assistance to the driver of the vehicle.

These and other embodiments may optionally include one or more of the following features.

The predetermined message can provide instructions to the driver for operating the vehicle.

The predetermined message can provide a message to the driver of a status of the vehicle.

The method can further include comparing the vehicle sensor input with a set of preset inputs stored in the data storage device, the set of preset inputs includes the preset input.

### BRIEF DESCRIPTION OF THE DRAWINGS

Other systems, methods, features, and advantages of the present invention will be apparent to one skilled in the art upon examination of the following figures and detailed description. Component parts shown in the drawings are not necessarily to scale and may be exaggerated to better illustrate the important features of the present invention.

FIG. 1A is a block diagram of a vehicle audible support system, according to an aspect of the invention.

FIG. 1B is a block diagram of example vehicle sensors for the vehicle audible support system of FIG. 1A, according to an aspect of the invention.

FIG. 2 is a flow chart illustrating a method for providing audible assistance and/or instruction to a driver of a vehicle, according to an aspect of the invention.

FIG. 3 is a block diagram of a vehicle audible support system, according to an aspect of the invention.

FIG. 4 is a block diagram of a vehicle audible support system, according to an aspect of the invention.

### DETAILED DESCRIPTION

Disclosed herein are systems, methods, devices, and/or vehicles for implementing a vehicle audible support system for providing real-time driver assistance based on vehicle sensor input. For example, the vehicle sensor input can be a turn signal remains on for greater than a predetermined duration while the vehicle continues moving straight. The vehicle audible support system automatically provides audible assistance and/or instruction to a driver of a vehicle when a vehicle sensor input is received that matches a predetermined vehicle sensor input or combination of vehicle sensor inputs, which can correspond to various scenarios where it is predetermined that driver assistance would be useful, for example. In this example the audible assistance or instruction to the driver of the vehicle can be “Please stop or shut off your turn signal if you are not turning.” The audible assistance can be played over the vehicle audio system. The audible assistance can play one or more predetermined and/or prerecorded instructions depending on the vehicle sensor input. The audible assistance can be triggered by a predetermined vehicle sensor input (e.g., via vehicle controls such as buttons, braking, etc.).

Various aspects of a vehicle audible support system provide drivers the support of what they may be trying to achieve at the time they need the information in a way that they can use while maintaining safe control of the vehicle (e.g., without taking eyes off the road). Various aspects of a vehicle audible support system allow for the driver to maintain eyes on the road while receiving information on vehicle controls.

Information can be played to the driver that may or may not be similar to or the same as the information that is available in the vehicle service manual. In this manner, a driver can be provided with vehicle operation and/or troubleshooting information in real-time without having to search a service manual or the internet while in a vehicle operating scenario.

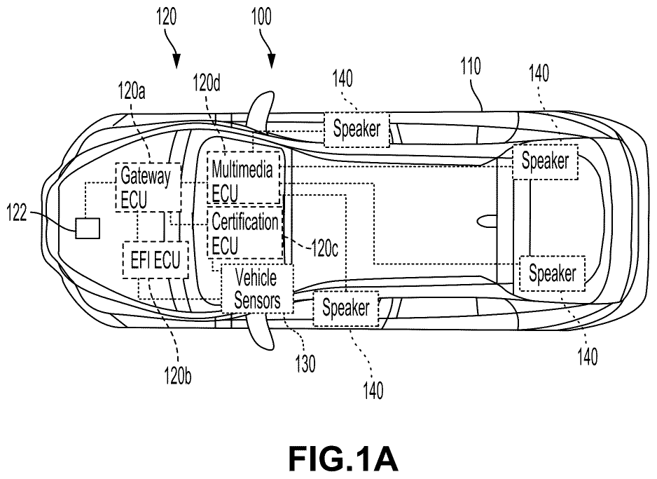

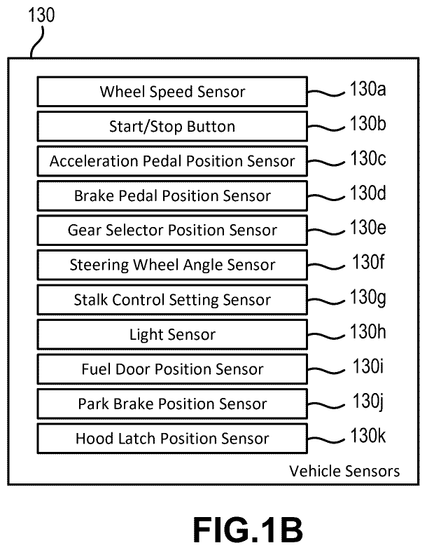

Referring now to FIGS. 1-4 the block diagrams and flow charts depicted are merely aspects or embodiments and are not intended to limit the scope of the disclosure. For example, the steps recited in any of the method or process descriptions may be executed in any order and are not limited to the order presented. Computer programs (also referred to as computer control logic) are stored in a memory. Computer programs may also be received via a communications interface. Such computer programs, when executed, enable the computer system to perform the features as discussed herein. In particular, the computer programs, when executed, enable the processor(s) to perform the features of various aspects or embodiments. Accordingly, such computer programs represent controllers of the computer system.

These computer program instructions may be loaded onto a general-purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

In various embodiments, software may be stored in a computer program product and loaded into a computer system using a removable storage drive, hard disk drive, or communications interface. The control logic (software), when executed by the processor, causes the processor to perform the functions of various embodiments as described herein. In various embodiments, hardware components may take the form of application specific integrated circuits (ASICs). Implementation of the hardware so as to perform the functions described herein will be apparent to persons skilled in the relevant art(s).

As used herein, “match” or similar terms may include an identical match, a partial match, meeting certain criteria, matching a subset of data, a correlation, satisfying certain criteria, a correspondence, an association, an algorithmic relationship, and/or the like.

The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” and “non-transitory computer-readable storage medium” should be construed to exclude only those types of transitory computer-readable media which were found in In re Nuijten to fall outside the scope of patentable subject matter under 35 U.S.C. § 101.

FIG. 1A is a block diagram of an audible support system 100 for a vehicle 110, in accordance with various aspects. The audible support system 100 may be retrofitted, coupled to, include or be included within the vehicle 110. The audible support system 100 monitors driver input and/or vehicle status (referred to collectively as vehicle sensor input) and outputs an audio message to the driver when the vehicle sensor input matches a preset input or a preset set of inputs that correspond to a scenario or a set of scenarios. The audible assistance is played over the vehicle's audio system and plays one or more prerecorded instructions depending on the vehicle sensor input.

The audible support system 100 may include or be retrofitted or otherwise coupled with the vehicle 110. The vehicle 110 is a conveyance capable of transporting a person, an object, or a permanently or temporarily affixed apparatus. The vehicle 110 may be a self-propelled wheeled conveyance, such as a car, a sports utility vehicle, a truck, a bus, a van or other motor, battery or fuel cell driven vehicle. For example, the vehicle 110 may be an electric vehicle, a hybrid vehicle, a hydrogen fuel cell vehicle, a plug-in hybrid vehicle or any other type of vehicle that has a fuel cell stack, a motor, and/or a generator. Other examples of vehicles include bicycles, trains, planes, or boats, and any other form of conveyance that is capable of transportation.

The audible support system 100 includes one or more processors, such as one or more electronic control units (ECUs) 120 and a memory 122. The audible support system 100 may include other components, such as one or more sensors 130 (also referred to herein as vehicle sensors). With reference to FIG. 1B, the one or more sensors 130 can include a wheel speed sensor 130a used to determine a speed of the vehicle 110. The one or more sensors 130 can include a start/stop button 130b used to start and/or stop the vehicle 110 (e.g., to turn on and off an engine or other drive system of the vehicle 110. The one or more sensors 130 can include an accelerator pedal position sensor 130c configured to measure a position and/or a deflection angle of a vehicle accelerator pedal. The one or more sensors 130 can include a brake pedal position sensor 130d configured to measure a position and/or a deflection angle of a vehicle brake pedal. The one or more sensors 130 can include a gear selector position sensor 130e configured to measure a position of a vehicle gear selector (e.g., to determine whether the vehicle is in a Park gear position, a Neutral gear position, a Drive gear position, etc.). The one or more sensors 130 can include a steering wheel angle sensor 130f configured to measure a position and/or angle of a vehicle steering wheel. The one or more sensors 130 can include a stalk control setting sensor 130g configured to detect a control setting of a vehicle stalk. The one or more sensors 130 can include a light sensor 130h (e.g., a sunlight sensor) configured to detect whether it is daytime or nighttime (i.e., whether it is light outside or dark outside). The one or more sensors 130 can include a fuel door or electric charge door position sensor 130i configured to detect a position of a vehicle fuel door and/or an electric charging inlet door (e.g., whether open or closed). In this regard, fuel door position sensor 130i as used herein can refer to a position sensor for a fuel door or an electric charging inlet door. The one or more sensors 130 can include a park brake position sensor 130j configured to detect a position of a vehicle park brake (e.g., whether engaged or disengaged). The one or more sensors 130 can include a hood latch position sensor 130k configured to detect whether a vehicle hood is fully latched (e.g., whether a hood latch is in a fully latched position). The one or more sensors 130 can include a battery charge sensor configured to detect the charge of one or more vehicle batteries. The one or more sensors 130 can include a fuel sensor configured to detect the fuel level of the fuel tank.

With reference to FIG. 1A, the one or more ECUs 120 may be implemented as a single ECU or as multiple ECUs or one or more processors. For example, the one or more ECUs 120 can include a gateway ECU 120a, an EFI ECU 120b, a certification ECU 120c, and/or a multimedia ECU 120d, referred to collectively herein as an ECU 120 or as one or more ECUs 120. The EFI ECU 120b can include hardware and software that controls the propulsion system of the vehicle. The certification ECU 120c can include hardware and software that confirms the correct vehicle key is in the proximity of the vehicle and signals other systems to activate into the applicable mode of function. The multimedia ECU 120d can include hardware and software that controls the multimedia systems (e.g., including audio) of the vehicle. The gateway ECU 120a can include hardware and software that interconnects and transfers data across the different networks, systems, and/or ECUs found in the vehicle. The ECU 120 may be electrically coupled to some or all of the other components within the vehicle 110, such as a motor and/or generator, a transmission, an engine, a battery, the memory 122, and/or the one or more sensors 130. The ECU 120 may include one or more processors or controllers specifically designed for (i) monitoring the one or more sensors 130 for vehicle sensor input and (ii) outputting an audio message to the driver when the vehicle sensor input matches a preset set of inputs that correspond to a set of scenarios.

The ECU 120 may be coupled to a memory 122 and can execute instructions that are stored in the memory 122. The memory 122 may be coupled to the ECU 120 and store instructions that the ECU 120 executes. The memory 122 may include one or more of a Random Access Memory (RAM) or other volatile or non-volatile memory. The memory 122 can be a tangible, non-transitory memory configured to communicate with the ECU 120. The memory 122 may be a non-transitory memory or a data storage device, such as a hard disk drive, a solid-state disk drive, a hybrid disk drive, or other appropriate data storage, and may further store machine-readable instructions, which may be loaded and executed by the ECU 120. Moreover, the memory 122 may be used to store the preset set of inputs that correspond to a set of scenarios.

The audible support system 100 can include one or more speakers 140. The speakers 140 can be vehicle speakers. In this regard, the audible support system 100 can utilize existing vehicle speakers 140 in the vehicle 110 for communicating audible messages to the driver which minimizes part count of the vehicle 110. The one or more ECUs 120 can be in electronic communication with the speakers 140. The one or more ECUs 120 can be configured to output an audio signal to the vehicle speakers 140 with a predetermined message based upon the vehicle sensor input detected via the one or more sensors 130. In one aspect, the one or more speakers 140 can be a single separate speaker (not connected to the vehicle audio system) directed towards the driver so other passengers may or may not be able to hear the predetermined message.

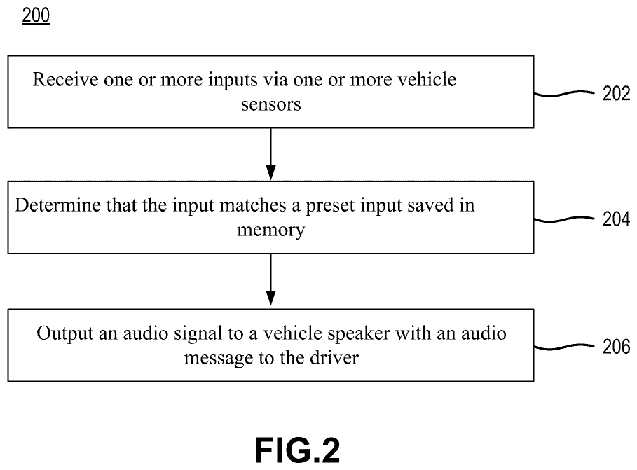

With reference to FIG. 2, a flowchart illustrating a method 200 for providing audible assistance and/or instruction to drivers of a vehicle is shown, in accordance with various aspects. For ease of description, the method 200 is described below with reference to FIG. 1A. The method 200 of the present disclosure, however, is not limited to use of the exemplary audible support system 100 of FIG. 1A.

In step 202, the method 200 includes receiving, by the ECU 120, one or more vehicle sensor inputs via the one or more vehicle sensors 130.

In step 204, the method 200 includes determining, by the ECU 120, that the vehicle sensor input matches a preset input stored in the memory 122. In various aspects, step 204 can include retrieving the preset inputs stored in the memory 122. The ECU 120 can determine that the vehicle sensor input (i.e., a sensor reading or a combination of sensor readings) is the same as one of the preset sensor readings or preset combination of sensor readings. An example preset combination of sensor readings that the ECU 120 can look for includes a first sensor reading indicating that a vehicle start/stop button is depressed while a second sensor reading indicates that a vehicle brake pedal is not depressed (e.g., in the event the vehicle requires the brake pedal to be depressed in order to start the vehicle). The combination could further include the wheel speed to confirm that the vehicle is stopped. However, it should be understood that a set of preset inputs can correspond to a variety of scenarios, sensor readings, and/or combination of sensor readings as described herein.

In step 206, the method 200 includes outputting, by the ECU 120, an audio signal to the speaker 140 to communicate an audio message to the driver based on the received vehicle sensor input. Step 206 can occur automatically (i.e., without human intervention) in response to the ECU 120 determining that the vehicle sensor input matches a preset input stored in the memory 122.

The ECU 120 can monitor the one or more vehicle sensors 130 for detecting vehicle sensor input that matches a scenario of a preset input stored in the memory 122.

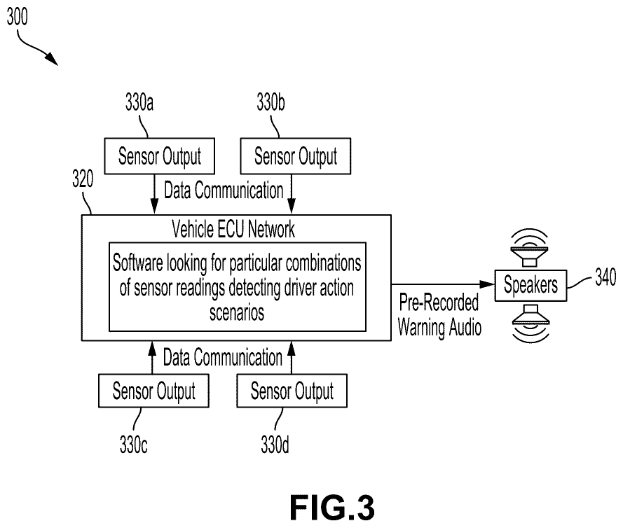

FIG. 3 is a block diagram of an audible support system 300, in accordance with various aspects. In various aspects, the audible support system 300 is similar to the audible support system 100 of FIG. 1A. The audible support system 300 generally includes one or more ECUs 320 (also referred to as a vehicle ECU network) configured to receive and monitor one or more vehicle sensor outputs (e.g., a first sensor output 330a, a second sensor output 330b, a third sensor output 330c, and a fourth sensor output 330d; referred to collectively as sensor outputs 330). Although illustrated as monitoring four vehicle sensor outputs, the vehicle ECU network 320 can be configured to monitor any number (e.g., 1-10) of vehicle sensor outputs as desired. For example, the vehicle ECU network 320 can be configured to monitor any of the vehicle sensors depicted in FIG. 1B.

Example sensor outputs 330 include a wheel speed, which is used interchangeably with a vehicle speed (e.g., received from a vehicle wheel speed sensor or a navigation unit), an accelerator pedal position (e.g., received from a vehicle accelerator pedal position sensor), a brake pedal position (e.g., received from a vehicle brake pedal position sensor), and a gear selector position (e.g., received from a vehicle gear selector position sensor), a push start switch input (e.g., received from a vehicle push start/stop button position sensor; also referred to as a push start switch input sensor), a steering wheel angle (e.g., received from a vehicle steering wheel angle sensor), a stalk control setting (e.g., received from a vehicle stalk control setting sensor), a light intensity (e.g., received from a vehicle light sensor), a fuel door position (e.g., received from a fuel door position sensor), a park brake position (e.g., received from a park brake position sensor), a hood latch position (e.g., received from a hood latch position sensor), and a battery charge percentage (e.g., received from a battery charge sensor or a battery management system).

In various aspects, the ECU network 320 can include software (e.g., instructions stored in memory) that cause the ECU network 320 to look for particular combination(s) of sensor readings to detect predetermined driver action scenarios. Example driver action scenarios include (i) a driver short presses a start/stop button while a vehicle speed is greater than zero, (ii) an accelerator input is detected while a brake is depressed for greater than a first predetermined duration (e.g., 1 second), (iii) a brake input is detected while the vehicle speed is not decreasing for greater than a second predetermined duration (e.g., 5 seconds), (iv) a vehicle is detected in a Neutral gear position while the vehicle speed is greater than zero, (v) an accelerator input is detected while the vehicle is in the Neutral gear position, (vi) the vehicle is out of a Park gear position while an ignition is off, (vii) a turn signal remains on for greater than a third predetermined duration while the vehicle continues moving straight, (viii) the turn signal remains on for greater than a predetermined distance while the vehicle continues moving straight, (ix) a fuel door (or an electric charging door) is open while the vehicle speed is greater than zero, (x) a parking brake is on while the vehicle is not in the Park gear position, (xi) a headlamp is set to an off position while a sensed light intensity indicates it is dark outside and the vehicle speed is greater than zero, (xii) a hood is not fully latched while the vehicle speed is greater than zero, (xiii) the hood is not fully latched while the vehicle is not in the Park gear position, and/or the battery is critically low (i.e., less than 10 percent charge).

In various aspects, and with reference to FIG. 1B, the first driver action scenario listed above can be detected by monitoring output from the wheel speed sensor 130a and the start/stop button 130b. In various aspects, the second driver action scenario listed above can be detected by monitoring output from the accelerator pedal position sensor 130c and the brake pedal position sensor 130d. In various aspects, the third driver action scenario listed above can be detected by monitoring output from the brake pedal position sensor 130d and the wheel speed sensor 130a. In various aspects, the fourth driver action scenario listed above can be detected by monitoring output from the gear selector position sensor 130e and the wheel speed sensor 130a. In various aspects, the fifth driver action scenario listed above can be detected by monitoring output from the accelerator pedal position sensor 130c and the gear selector position sensor 130e. In various aspects, the sixth driver action scenario listed above can be detected by monitoring output from the gear selector position sensor 130e and the start/stop button 130b. In various aspects, the seventh driver action scenario listed above can be detected by monitoring output from the stalk control setting sensor 130g and the steering wheel angle sensor 130f. In various aspects, the eighth driver action scenario listed above can be detected by monitoring output from the stalk control setting sensor 130g, the wheel speed sensor 130a, and the steering wheel angle sensor 130f. In various aspects, the ninth driver action scenario listed above can be detected by monitoring output from the fuel door position sensor 130i and the wheel speed sensor 130a. In various aspects, the tenth driver action scenario listed above can be detected by monitoring output from the park brake position sensor 130j and the gear selector position sensor 130e. In various aspects, the eleventh driver action scenario listed above can be detected by monitoring output from the stalk control setting sensor 130g (i.e., whether the headlamp is turned on or off) and the light sensor 130h. In various aspects, the twelfth driver action scenario listed above can be detected by monitoring output from the hood latch position sensor 130k and the wheel speed sensor 130a. In various aspects, the thirteenth driver action scenario listed above can be detected by monitoring output from the hood latch position sensor 130k and the gear selector position sensor 130e.

In response to detecting a driver action scenario that matches a predetermined scenario/input stored in a data storage device (e.g., stored in a memory, such as the memory 122 of FIG. 1A), the ECU network 320 can output an audio signal to one or more vehicle speakers 340 with a predetermined message based upon the vehicle sensor input. The audio signal can be stored in the data storage device (e.g., see the memory 122 of FIG. 1A). Example messages include “to stop engine press and hold start button,” “brake input detected, to stop engine press and hold start button,” “vehicle in Neutral, to stop engine press and hold start button,” “vehicle is out of Park,” “turn signal on,” “fuel door open,” “park brake on,” “headlamps switched off,” and “hood open.” Stated differently, example messages include providing audible instructions to the driver on how to stop the vehicle engine, an audible message that a brake input is detected with instruction to the driver on how to stop the vehicle engine, an audible message that the vehicle is in Neutral with instruction to the driver on how to stop the vehicle engine, an audible message to the driver that the vehicle is out of Park, an audible message to the driver that the turn signal is on, an audible message to the driver that the fuel lid is open, an audible message to the driver that the park brake is on, an audible message to the driver that the headlamps are switched off, an audible message to the driver that the vehicle hood is open, and an audible message to the driver that the battery or the fuel is critically low. In this regard, the audible message can provide instructions to the driver for operating the vehicle and/or a message to the driver indicating a status of the vehicle (e.g., a status of a vehicle component).

In an example, the sensor output 330a is received from a start/stop button of the vehicle (e.g., see start/stop button 130b of FIG. 1B) and the vehicle sensor input includes a depressing of the start/stop button. Stated differently, the sensor output 330a can indicate that the start/stop button has been depressed by the driver. For example, a preset driver scenario can be when a driver is trying to start a vehicle that requires the brake pedal to be depressed when the start/stop button is depressed to start the vehicle. If the driver is not depressing the brake pedal but is depressing the start/stop button while the vehicle is in Park, then the audible support system 300 can detect the error by the driver and output an audible message to the driver with instructions on how to properly start the vehicle. It should be understood that this is merely one example of many scenarios that the audible support system 300 can be used for assisting the driver of the vehicle.

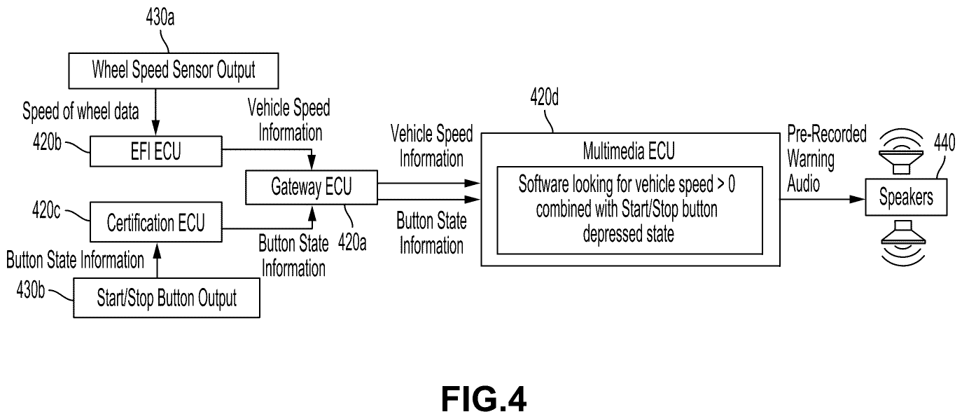

FIG. 4 is a block diagram of an audible support system 400, in accordance with various aspects. In various aspects, the audible support system 400 is similar to the audible support system 100 of FIG. 1A. The audible support system 400 generally includes one or more ECUs 420 (also referred to as a vehicle ECU network) configured to receive and monitor one or more vehicle sensor outputs (e.g., a first sensor output 430a and a second sensor output 430b; referred to collectively as sensor outputs 430). Although illustrated as monitoring two vehicle sensor outputs, the vehicle ECUs 420 can be configured to monitor any number of vehicle sensor outputs as desired. For example, the vehicle ECUs 420 can be configured to monitor any of the vehicle sensors depicted in FIG. 1B.

The ECUs 420 can include a gateway ECU 420a, an EFI ECU 420b, a certification ECU 420c, and a multimedia ECU 420d. The EFI ECU 420b can be configured to receive a first sensor output 430a, such as a wheel speed sensor output. The EFI ECU 420b can send vehicle speed information to the gateway ECU 420a based upon the first sensor output 430a. The certification ECU 420c can be configured to receive a second sensor output 430b, such as a start/stop button output. The certification ECU 420c can send button state information to the gateway ECU 420a based upon the second sensor output 430b. The gateway ECU 420a can send or transmit the vehicle speed information and the button state information to the multimedia ECU 420d. The multimedia ECU 420d can include software configured to detect vehicle speed greater than zero combined with a start/stop button depressed state using the vehicle speed information and the button state information. In response to detecting that the vehicle speed is greater than zero and the start/stop button is in a depressed state, the multimedia ECU 420d can be configured to send an audio signal to one or more speakers 440 so as to play an audible message to the driver with instructions on how to stop the vehicle engine. For example, the audible message can inform the driver to stop the vehicle and press the start/stop button three times in order to shut down the vehicle engine. The audible message can be a pre-recorded audio message stored in a data storage device, such as memory 122 of FIG. 1, for example.

It should be understood that various driver scenarios can be detected by the audible support system 400 based on vehicle speed and start/stop button state information for assisting a driver. It should be further understood that various driver scenarios can be detected by the audible support system 400 using various other sensor outputs as described herein.

Exemplary embodiments of the invention have been disclosed in an illustrative style. Accordingly, the terminology employed throughout should be read in a non-limiting manner. Although minor modifications to the teachings herein will occur to those well versed in the art, it shall be understood that what is intended to be circumscribed within the scope of the patent warranted hereon are all such embodiments that reasonably fall within the scope of the advancement to the art hereby contributed, and that that scope shall not be restricted, except in light of the appended claims and their equivalents.

1. A vehicle audible support system comprising:
one or more vehicle sensors configured to detect an input corresponding to a characteristic of a vehicle or its surroundings;
a data storage device configured to store a preset input; and
one or more processors configured to be in electronic communication with the data storage device, the one or more processors configured to:
receive a vehicle sensor input from the one or more vehicle sensors; and
in response to determining that the vehicle sensor input matches the preset input, output an audio signal to a vehicle speaker with a predetermined message based upon the vehicle sensor input to provide assistance to a driver of the vehicle.

2. The vehicle audible support system of claim 1, wherein the one or more processors is configured to monitor the one or more vehicle sensors for the vehicle sensor input.

3. The vehicle audible support system of claim 1, wherein:
the one or more vehicle sensors includes a start/stop button of the vehicle; and
the vehicle sensor input includes a depressing of the start/stop button.

4. The vehicle audible support system of claim 1, wherein the one or more vehicle sensors includes a wheel speed sensor.

5. The vehicle audible support system of claim 1, wherein the one or more vehicle sensors includes at least one of a wheel speed sensor, an accelerator pedal position sensor, a brake pedal position sensor, and gear selector position sensor, a push start switch input sensor, a steering wheel angle sensor, a stalk control setting sensor, a light sensor, a fuel door position sensor, a park brake position sensor, and a hood latch position sensor.

6. The vehicle audible support system of claim 1, wherein the preset input corresponds to at least one or more of the following scenarios:
the driver short presses a start/stop button while a vehicle speed is greater than zero;
an accelerator input is detected while a brake is depressed for greater than a first predetermined duration;
a brake input is detected while the vehicle speed is not decreasing for greater than a second predetermined duration;
the vehicle is detected in a Neutral gear position while the vehicle speed is greater than zero;
the accelerator input is detected while the vehicle is in the Neutral gear position;
the vehicle is out of a Park gear position while an ignition is off;
a turn signal remains on for greater than a predetermined duration while the vehicle continues moving straight;
the turn signal remains on for greater than a predetermined distance while the vehicle continues moving straight;
a fuel or electric charge door is open while the vehicle speed is greater than zero;
a parking brake is on while the vehicle is not in the Park gear position;
a headlamp is set to an off position while a sensed light intensity indicates it is dark outside and the vehicle speed is greater than zero;
a hood is not fully latched while the vehicle speed is greater than zero; and
the hood is not fully latched while the vehicle is not in the Park gear position.

7. The vehicle audible support system of claim 1, wherein the predetermined message includes an audible message to the driver that at least one or more of:
provide instructions to the driver on how to stop a vehicle engine;
a brake input is detected;
the vehicle is in Neutral;
the vehicle is out of Park;
a turn signal is on;
a fuel or electric charge door is open;
a parking brake is on;
a headlamp is switched off; and/or a vehicle hood is open.

8. The vehicle audible support system of claim 1, wherein the one or more processors includes at least one of an EFI ECU or a certification ECU configured to receive the vehicle sensor input via the one or more vehicle sensors.

9. The vehicle audible support system of claim 8, wherein the one or more processors further includes a multimedia ECU configure to send the audio signal to the vehicle speaker.

10. A vehicle comprising:
a vehicle speaker;
one or more vehicle sensors; and
a vehicle audible support system including one or more processors in electronic communication with the one or more vehicles sensors and a data storage device, the one or more processors configured to:
receive a vehicle sensor input via the one or more vehicle sensors; and
in response to determining that the vehicle sensor input matches a preset input stored in the data storage device, output an audio signal to the vehicle speaker with a predetermined message based upon the vehicle sensor input to provide assistance to a driver of the vehicle.

11. The vehicle of claim 10, wherein the one or more processors is configured to monitor the one or more vehicle sensors for the vehicle sensor input.

12. The vehicle of claim 10, wherein:
the one or more vehicle sensors includes a start/stop button of the vehicle; and
the vehicle sensor input includes a depressing of the start/stop button.

13. The vehicle of claim 10, wherein the one or more vehicle sensors includes a wheel speed sensor.

14. The vehicle of claim 10, wherein the one or more vehicle sensors includes at least one of a wheel speed sensor, an accelerator pedal position sensor, a brake pedal position sensor, and gear selector position sensor, a push start switch input sensor, a steering wheel angle sensor, a stalk control setting sensor, a light sensor, a fuel door position sensor, a park brake position sensor, and a hood latch position sensor.

15. The vehicle of claim 10, wherein the one or more processors includes at least one of an EFI ECU or a certification ECU configured to receive the vehicle sensor input via the one or more vehicle sensors.

16. The vehicle of claim 15, wherein the one or more processors further includes a multimedia ECU configure to send the audio signal to the vehicle speaker.

17. A method for providing assistance to a driver of a vehicle, the method comprising:
receiving a vehicle sensor input at one or more processors via one or more vehicle sensors, the one or more processors are in electronic communication with one or more vehicles sensors and a data storage device; and
in response to determining that the vehicle sensor input matches a preset input stored in the data storage device, outputting an audio signal to a vehicle speaker with a predetermined message based upon the vehicle sensor input to provide the assistance to the driver of the vehicle.

18. The method of claim 17, wherein the predetermined message provides instructions to the driver for operating the vehicle.

19. The method of claim 17, wherein the predetermined message provides a message to the driver of a status of the vehicle.

20. The method of claim 17, further comprising comparing the vehicle sensor input with a set of preset inputs stored in the data storage device, the set of preset inputs includes the preset input.
